(19) United States
(12) Patent Application Publication
(10) Pub. No.: US 2011/0026523 A1
(43) Pub. Date: Feb. 3, 2011

(54) Network Node Of A Packet Switching Communications Network And Method For The Distribution Of Data Traffic In A Packet Switching Communications Network

(75) Inventors: Joachim Charzinksi, Munchen (DE); Andreas Kirstadter, Ebersberg (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Muenchen (DE)

(21) Appl. No.: 10/558,512

(22) PCT Filed: May 28, 2004
(86) PCT No.: PCT/EP2004/050953

§ 371 Date: May 19, 2010

(30) Foreign Application Priority Data
May 28, 2003 (DE) 103 24 370.4

(51) Int. Cl. H04L 12/56

(52) U.S. Cl. 370/392

(57) ABSTRACT

Several network node addresses are assigned to at least one link in a network node of a packet switching communications network that contains several network nodes and several links leading to other network nodes. The data-packet traffic that arrives at the network node is divided between the number of configured network node addresses that lead to a target network node and is transmitted.

### CROSS REFERENCE TO RELATED APPLICATIONS

This application is the US National Stage of International Application No. PCT/EP2004/050953, filed May 28, 2004 and claims the benefit thereof. The International Application claims the benefits of German application No. 10324370.4 DE filed May 28, 2003, both of the applications are incorporated by reference herein in their entirety.

### FIELD OF INVENTION

This invention relates to a network node of a packet switching communications network and a method for the distribution of data traffic in a packet switching communications network.

### BACKGROUND OF INVENTION

Packet switching communications networks, such as an Internet Protocol network—IP network—for example, transmit electronic data in packets from a source network node to a destination network node by way of different intermediate network nodes of the communications network, whereby each network node of the communications network can assume the function of a source or destination network node for data packets. The network nodes are connected to one another by means of connections, connection paths or links. The connection paths end at individual interfaces of the network node. In this situation, at least one network node address, an IP address for example, is assigned to each of these network nodes, such as routers, switches, gateways, bridges, network elements etc., whereby the network node address can also be assigned to the network node interface. The network node addresses are distributed by way of routing protocols, such as OSPF, RIP, BGP, IS-IS etc., to the network nodes of the communications network such that each network node has information concerning the communications network and each is able to calculate and store routes to all network nodes of the communications network. In this situation, the routes or routing paths to a destination network node are saved in a so-called routing table in the network node. This contains the network node address of the destination network node, the network node address of the adjacent network node leading to this destination and the interface or the interface identification number, interface ID for short, of the home network node to which a link to this adjacent network node is connected. Incoming data packets having a destination network node address can be routed to the destination network node by using the routing table. In this situation, the destination network node address is compared with the entries in the routing table and when a match is found the adjacent network node and the interface from which the packet is transmitted via the adjacent network node to the destination network node are ascertained.

If a plurality of parallel paths exists to a destination network node, then in the case of the normal single path routing only one path is used. In this situation, the path selection is carried out depending on the particular implementation in question.

An alternative to this is to use Multiprotocol Label Switching, MPLS for short. In this situation, states are maintained across the network which define the paths on which packets are conveyed through the network bypassing the normal routing, such as IP routing. In this situation, the network nodes no longer route packets by using the destination addresses, instead a bit string, a so-called label, is prefixed to each packet at the network entry. This label, which is evaluated in each network node, determines the path on which the packets are to be routed. The relationship between labels and paths must be established during commissioning of the network. The label is removed again at the network exit. In addition, mechanisms or rules are needed locally in order to divert packets onto a substitute path if the path originally provided fails or in order to establish a substitute path following a failure.

A further variant in the case of two or more equal paths is the so-called Equal Cost Multi Path method, ECMP for short, in the case of the OSPF protocol. In this situation, given equal paths the data packet traffic is divided up evenly. In other words, when there are two paths each path receives 50% of the data traffic, when there are three paths each path receives 33% etc. In concrete terms, this means that given two equal paths every second data packet is conveyed over the second path or a first data packet flow, in other words a sequence of data packets, is sent over the first path and a second data packet flow is sent over the second path etc., with the result that an even traffic distribution of the data packet traffic onto the paths is achieved on average.

### SUMMARY OF INVENTION

An object of the present invention is to set down a network node in such a manner as to allow the implementation of a flexible division of the data traffic to a destination network node.

This object is achieved by a network node and method according to the features described in the claims.

The assignment of further network node addresses to a connection path of a network node is recognized by the network node as a further connection path. If a plurality of paths from one network node to another network node exists as a result, then by configuring the number or making a selection from the number of configured further connection paths over which data packets are to be transmitted it is possible to achieve an uneven distribution of the data packet traffic.

Advantageous embodiments of the invention are set down in the dependent claims.

In an advantageous embodiment the network node according to the invention is described, using a multi path routing method. This has the advantage that a standardized method, such as ECMP for example, is flexibilized by the method according to the invention. A freer traffic distribution is possible, for which reason the network can be loaded more evenly, thereby making available increased performance reserves.

### BRIEF DESCRIPTION OF THE DRAWINGS

An embodiment of the invention is illustrated in the drawing and will be described in the following. In the drawing:

FIG. 1 shows two network nodes which are linked by means of two connection paths,

FIG. 2 shows a network comprising a plurality of network nodes.

### DETAILED DESCRIPTION OF INVENTION

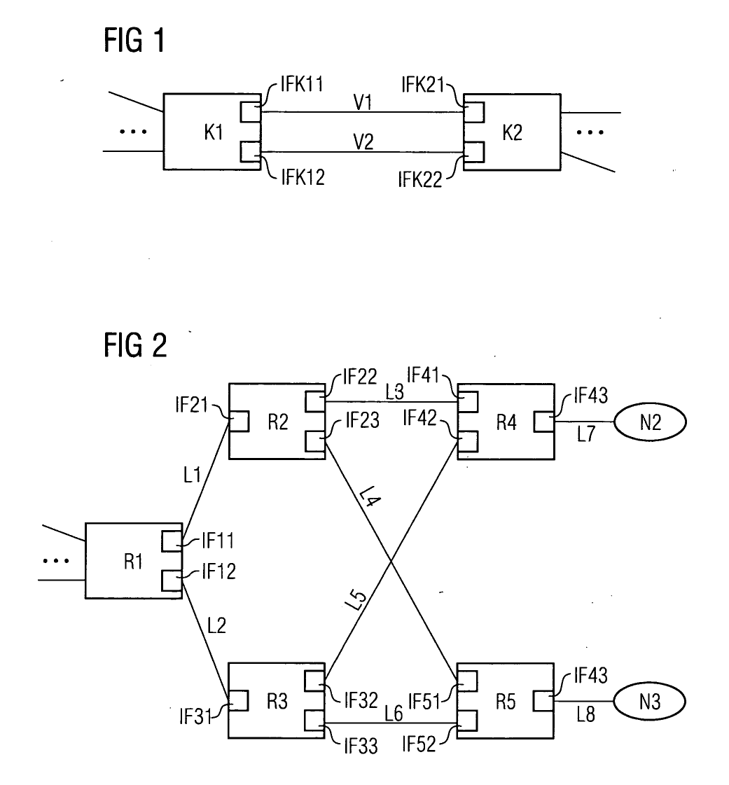

FIG. 1 shows a partial area of a packet switching communications network in which two network nodes K1 and K2 are connected to one another by way of two connections, connection paths, or links V1 and V2. The connections can for example be two-wire lines, coaxial cables or fiber optic cables. The connection V1 is connected at the network node K1 to an interface IFK11 assigned to network node K1 and at the network node K2 to an interface IFK21 assigned to network node K2. In similar fashion, the second connection V2 is connected at the network node K1 to an interface IFK12 assigned to network node K1 and at the network node K2 to an interface IFK22 assigned to network node K2.

According to the prior art, in the case of normal single path routing, such as OSPF, only one of the two connections V1 or V2 is used. The selection of the connection is dependent on the implementation and moreover there is no guarantee that the network nodes K1 and K2 will use the same connection in their respective transmission direction.

If the same routing costs or routing metrics are assigned to the connections V1 and V2 and if ECMP is activated, then both connections are used. Data packets are then distributed onto the connections either packet by packet or using data packet flow, depending on the configuration, with the result that on average a ratio of 1:1 is achieved for the loading of the connections.

By way of example, the interfaces have the following IP addresses, whereby the associated IP networks should each have a /24 prefix:

IFK11 10.2.0.1

IFK12 10.2.1.1

IFK21 10.2.0.2

IFK22 10.2.1.2

The routing table in network node K1 for a destination “108.13.2.0/24” accessible by way of K2 then appears as follows, for example, where Destination=destination network node address or destination network address, Next hop=adjacent network node and Interface=interface ID.

| Destination | Next Hop | Interface |
|---|---|---|
| 108.13.2.0/24 | 10.2.0.2 | IRK11 |
| | 10.2.1.2 | IFK12 |

An analogous routing table is contained in network node K2 which routes data packets or traffic to the network node K1 by way of its two interfaces IFK21 and IFK22 to the Next Hop addresses 10.2.0.1 and 10.2.1.1.

If data packets are to be distributed unevenly to the connections, according to the invention further so-called “virtual” interfaces are configured. This is done by further network addresses or IP addresses being configured on the interfaces.

By way of example, the following addresses are additionally configured (again with the prefix /24):

IFK11 10.2.2.1

IFK21 10.2.2.2

These two so-called virtual addresses are active in the same way as the primary addresses of IFK11 and IFK21 and can accept data traffic.

The routing table in network node K1 then appears as follows:

| Destination | Next Hop | Interface |
|---|---|---|
| 108.13.2.0/24 | 10.2.0.2 | IFK11 |
| | 10.2.1.2 | IFK12 |
| | 10.2.2.2 | IFK11 |

The data packet traffic to the destination network node “108.13.2.0/24” by way of the network node K2 is now divided up in the network node K1 onto three network node addresses or network addresses, whereby each network node address or network address carries ⅓ of the total traffic. Since two of the network node addresses use the same physical interface and thus the same physical connection, the connections V1 and V2 carry the traffic at a 2:1 ratio.

When using this principle, any desired distributions can be achieved for the data traffic on a plurality of physical connection paths. By setting up further network node addresses to the physical connections or physical interfaces or by setting up further virtual interfaces it is possible to enable any desired data traffic distribution ratios k/m (where k and m are integers).

In order to divide up the traffic unevenly, there need not be two or more direct parallel connections present between two network nodes. If a plurality of network node addresses or IP addresses are assigned in similar fashion to interfaces or connection paths of a network node which lead to the other network nodes and if a multi path routing method is employed, the traffic in the network can be dynamically divided up unevenly.

IP addresses are subdivided into a so-called network part and a so-called host part. These were previously defined by the so-called Classes {Class A, B, C, D) or by the so-called subnetwork masks. They are now defined by the prefixes. When the IP addresses are allocated to the interfaces it is advantageous in this situation to assign new IP network addresses or network addresses to the interfaces in each case, such as they have been used in the example. In this situation, the same IP network number or IP network address is configured in paired fashion in each case in both network nodes of a connection, whereby the paired network numbers are allocated individually in each case. As a result, each connection set up corresponds to a separate IP network, as is usual in IP networks.

The method according to the invention can also be applied to static routing. For example, different traffic distributions can be set up in a network node for different destinations, destination network nodes or destination subnetworks. The method according to the invention can likewise be used in the case of a combination of dynamic and static routing. For individual destinations it is possible to disregard the dynamic routing using the established traffic distribution and to set up static routing with a completely different traffic distribution. Furthermore, static routes can for example be entered by means of which the traffic is distributed over a plurality of network nodes on paths which in the context of OSPF and ECMP are not “equal cost”. In this situation it is important to ensure during the configuration that the routes remain free of loops.

In the case of static routing, the management of the addresses is usefully separated from the management of the static routes so that there is no need to configure new interface addresses or remove them for each change in the traffic distribution. It is advisable, for example, to permanently configure a certain number of addresses per connection or link. In this situation, IP networks of a minimum size can be used in each case with regard to the point-to-point links assumed here, for example having the network prefix /30. Four IP addresses are thus used per link. For a resource-optimized assignment of four addresses in each case to the interfaces according to FIG. 1 the following eight networks would be selected, for example:

### 10.2.0.0/30, 10.2.0.4/30, 10.2.0.8/30, 10.2.0.12/30 for L1

### 10.2.0.16/30, 10.2.0.20/30, 10.2.0.24/30, 10.2.0.28/30 for L2

The interface addresses would then be, for example:

### IF11: 10.2.0.1, 10.2.0.5, 10.2.0.9, 10.2.0.13

### IF21: 10.2.0.2, 10.2.0.6, 10.2.0.10, 10.2.0.14

### IF12: 10.2.0.17, 10.2.0.21, 10.2.0.25, 10.2.0.29

### IF22: 10.2.0.18, 10.2.0.22, 10.2.0.26, 10.2.0.30

With regard to static routing, only the corresponding next hops are entered into and removed from the routing table in order to change the load distribution.

In addition to static routing, if certain limit conditions are observed such as appropriate setting of the routing metrics it is also possible for a routing protocol such as OSPF to run as backup with the result that a path is still found in any case even if no further functioning static next hop for a destination should be present in the routing table.

The parallel operation of a conventional routing protocol in the background moreover has the advantage that the reappearance of a connection is automatically recognized. It is also possible to use a fast error recognition facility.

The calculation of paths or routes in the communications network can be carried out locally in the network nodes. The traffic distribution can on the other hand be coordinated globally, for example by a central control unit such as a Network Control Server NCS, or by intercommunication between the network nodes by means of a suitable protocol.

It is also possible to use a protocol through which a network node notifies its adjacent network node that it should configure a further virtual IP address for an interface. This can be done by referencing the primary IP address of the interface and additionally specifying an address and an IP network number and conveying this to the adjacent network node by means of a protocol, such as 10.2.0.18 and 10.2.0.16/30 in the case of the example given above.

FIG. 2 shows a section of a communications network, consisting of five network nodes R1 to R5 and two subnetworks N2 and N3. The network node R1 is on the one hand connected to a communications network which is not shown and on the other hand has two interfaces IF11 and IF12. The interface IF11 is connected by means of a connection L1 to an interface IF21 of the network node R2 which in turn has two further interfaces IF22 and IF23. The interface IF22 is connected by means of a connection L3 to an interface IF41 of the network node R4 which likewise has two further interfaces IF42 and IF43. The interface IF43 is connected by means of a connection L7 to the subnetwork N2.

The interface IF12 of the network node R1 is connected by means of a connection L2 to an interface IF31 of the network node R3 which also has two further interfaces IF32 and IF33. The interface IF33 is connected by means of a connection L6 to an interface IF52 of the network node R5 which has two further interfaces IF51 and IF53. The interface IF53 is connected by means of a connection L8 to the subnetwork N3. Furthermore, the interface IF23 of the network node R2 is connected by means of a connection L4 to the interface IF51 of the network node R5 and the interface IF32 of the network node R3 is connected by means of a connection L5 to the interface IF42 of the network node R4.

A description is given with reference to FIG. 2 as to how the proposed method is used for different destinations, destination network nodes or destination subnetworks. The network node R1 should distribute traffic or data packets to the subnetwork N2 in the ratio 2:1 and traffic to the subnetwork N3 in the ratio 1:3 onto the lines L1 and L2.

The interface addresses of the network nodes R1, R2 and R3 are set as follows:

| | | |
|---|---|---|
| Network 10.0.0.0/30 | IF11 (10.0.0.1, primary) | IF21 (10.0.0.2, primary) |
| Network 10.0.0.4/30 | IF11 (10.0.0.5, secondary) | IF21 (10.0.0.6, secondary) |
| Network 10.0.0.8/30 | IF12 (10.0.0.9, primary) | IF31 (10.0.0.10, primary) |
| Network 10.0.0.12/30 | IF12 (10.0.0.13, secondary) | IF31 (10.0.0.14, secondary) |
| Network 10.0.0.16/30 | IF12 (10.0.0.17, secondary) | IF31 (10.0.0.18, secondary) |

In the following routing table of the network node R1 the traffic from the network node R1 to the network N2 is divided up in the ratio 2:1 and the traffic from the network node R1 to the network N3 is divided up in the ratio 1:3 onto the lines L1 and L2:

| Destination | Next Hop | Interface |
|---|---|---|
| N2 | 10.0.0.2 | IF11 |
| | 10.0.0.6 | IF11 |
| | 10.0.0.10 | IF12 |
| N3 | 10.0.0.2 | IF11 |
| | 10.0.0.10 | IF12 |
| | 10.0.0.14 | IF12 |
| | 10.0.0.18 | IF12 |

When using static routes, the virtual addresses do not need to be incorporated in a symmetrical manner into the routing, in other words the traffic distribution can be different in both directions. In larger networks this will even be the rule on account of the freedom from loops required for packet routing.

If no static routes are used, address pools from which the new virtual IP addresses of the interfaces are taken could be configured for the routers. As soon as an additional address has been configured on both sides of a link, it can be automatically taken into operation by the routing protocol, for example OSPF with ECMP.

The allocation of multiple IP addresses for one interface can be used in the case of classic OSPF with ECMP in order to achieve a suitable traffic distribution in a network with links of differing bandwidth. If, for example, the connection L1 in FIG. 1 had a transmission bandwidth of 155 Mbit/s and the connection L2 had a transmission bandwidth of 622 Mbit/s, then in order to divide up the traffic in accordance with the link bandwidth one would configure four network node addresses or IP addresses for the connection L2 and only one network node address or IP address for the connection L1 per side.

1.-16. (canceled)

17. A network node of a packet switching communications network, comprising:
a first plurality of network node addresses assigned to a connection path of the network node, the connection path leading to an adjacent network node; and
a data packet arriving in the network node divided between and transmitted to a configured number of network node addresses that lead to a destination network node.

18. The network node according to claim 17, wherein the connection path is associated to a network node interface of the network node, and a second plurality of network node address are assigned to the network node interface.

19. The network node according to claim 18, wherein the first and second plurality of network node addresses are transmitted to the adjacent network node.

20. The network node according to claim 19, wherein a number of the first or second plurality of network node addresses is the same at the adjacent network node.

21. The network node according to claim 20, wherein the first or second plurality of network node addresses present are configured such that each network node address of a network node forms a pair with a network node address of the adjacent network node, whereby the network node and the adjacent network node have the same network proportion.

22. The network node according to claim 21, wherein an individual network proportion is assigned to the network node address pair.

23. The network node according to claim 22, wherein the network node contains a control table in which the connection paths connected to the network node and the network node addresses entered for each connection path are stored.

24. The network node according to claim 23, wherein the network node uses a multi-path routing method.

25. The network node according to claim 24, wherein the network node addresses are Internet Protocol addresses.

26. A method by a network node for traffic distribution of data packets to be transmitted to a destination network node in a packets switching communication network, comprising:
providing a plurality of connection paths leading to other network nodes;
providing a plurality of network node addresses assigned to at least one of the plurality of connection paths;
dividing a data packet traffic arriving in the network node by the number of assigned network node addresses leading to a destination network node; and
transmitting the divided packets towards the destination network node.

27. The method according to claim 26, further comprising sending the network node addresses of a network node that are assigned to a connection path to an adjacent network node.

28. The method according to claim 27, wherein the number of network node addresses set up in the network node per connection path is the same as the number set up in another network node connected at the other end of the connection path.

29. The method according to claim 28, wherein the network node addresses present in the network node and another network node forms a pair, whereby the network node and another network node have the same network proportion.

30. The method according to claim 29, wherein an individual network proportion is assigned to each network node address pair.

31. The method according to claim 29, wherein the network node address are formed using an Internet Protocol address.

32. The method according to claim 29, wherein the network node uses a multi-path routing method.
